(19) United States
(12) Patent Application Publication
(10) Pub. No.: US 2001/0022028 A1
(43) Pub. Date: Sep. 20, 2001

(54) Scissors

(76) Inventor: Andrew Stokes, Sheffield (GB)

Correspondence Address: TREXLER, BUSHNELL, GIANGIORGI,, BLACKSTONE & MARR, LTD., 36TH FLOOR, 105 WEST ADAMS STREET, CHICAGO, IL, 60603, US

(21) Appl. No.: 09/767,181

(22) Filed: Jan. 22, 2001

(30) Foreign Application Priority Data
Feb. 3, 2000 (GB) 0002438.0

(51) Int. Cl. B26B 13/00; B26B 19/00

(52) U.S. Cl. 30/194

(57) ABSTRACT

The invention relates to scissors. Hitherto scissors have been formed with rigid and identical handles to allow use in either hand, but with some discomfort to the user, or with handles specifically shaped to suit a right-handed or a left-handed user, but not both. The object of the invention is to provide a pair of scissors able to be used in comfort by both right-handed and left-handed users, an objective met by a construction comprising blades and associated handles pivotally secured together, the handles forming respective finger and thumb bows that are symmetrical about the center plane at the mid-point through their thickness, at least one (thumb) bow being formed as a rigid structure from the forward end towards the pivot to a point along the length of that bow, from where the at least one (thumb) bow has a rearward part formed from a form-stable but resilient and/or flexible material.

This invention relates to scissors.

It has long been known to manufacture scissors with finger and thumb bows either of the same size or with the finger bow larger than the thumb bow, and with both bows symmetrical about a central plane mid-point of the handle thickness. So formed, the scissors can be used in both the left and right hand, but with the scissors not ideally suited for use in either hand.

To make scissors more comfortable to use, it has long been known to shape the finger and/or thumb bows to better suit their engagement by the hand of the user. However, and hitherto, shaping scissor bows has only been done to suit either the right hand or the left hand, and not both, and as there are greater numbers of right handed prospective users of scissors, it has been so that right handed scissors have been dominant, to the disadvantage of lefthanded users.

The object of the invention is to provide a pair of scissors able to be used in comfort by both right handed and left handed users.

According to the present invention, a pair of scissors comprises blades and associated handles pivotally secured together, the handles forming respective finger and thumb bows that are symmetrical about the centre plane at the mid-point through their thickness, at least one (thumb) bow being formed as a rigid structure from the forward end towards the pivot to a point along the length of that bow, from where the at least one (thumb) bow has a rearward part formed from a form-stable but resilient and/or flexible material.

Preferably the aperture through the at least one (thumb) bow is formed wholly within the part of that bow formed from resilient and/or flexible material.

The other (finger) bow of the pair of scissors may be formed from hard material in conventional manner but preferably is also formed partly from hard material and partly from form—stable but resilient and/or flexible material, and again, it is desirable for the aperture in the other (finger) bow to be formed wholly within the part of that bow formed from resilient and/or flexible material.

For smaller scissors, it is conventionally so that the two bows are identically formed and this may be so with scissors of the invention. Thus, the handles may be identically formed as forward sections of hard material, and rearward sections containing the bows for the finger and the thumb respectively of either the left or the right hand. When the scissors are closed with reasonable force to cut the material placed between the blades, pressure from the thumb at least, is applied to the resilient and/or flexible section of the respective bow, to cause the rearward portion of the bow to flex, to the considerable comfort to the user, whether they be right or left handed.

With regard to both larger and smaller scissors, the hard material of the parts of the handles towards the pivots is preferably polypropylene, and the resilient/flexible material of the rearward section is preferably santropene.

For larger scissors, it is customary for the finger bow to be larger than the thumb bow and allow several fingers to engage in the aperture. Here again whether used in the left or the right hand, a cutting force applied to the bows causes at least the thumb bow to yield or flex, to the considerable comfort to users whether they be right or left handed. With large scissors, the hard material of the forward part of the finger bow may be extended further along that bow over its upper and/or lower edge to provide a greater stability in the finger bow to resist the force applied by the fingers during the cutting action.

Two embodiments of the invention will now be described by way of example only with reference to the accompanying drawings, in which:

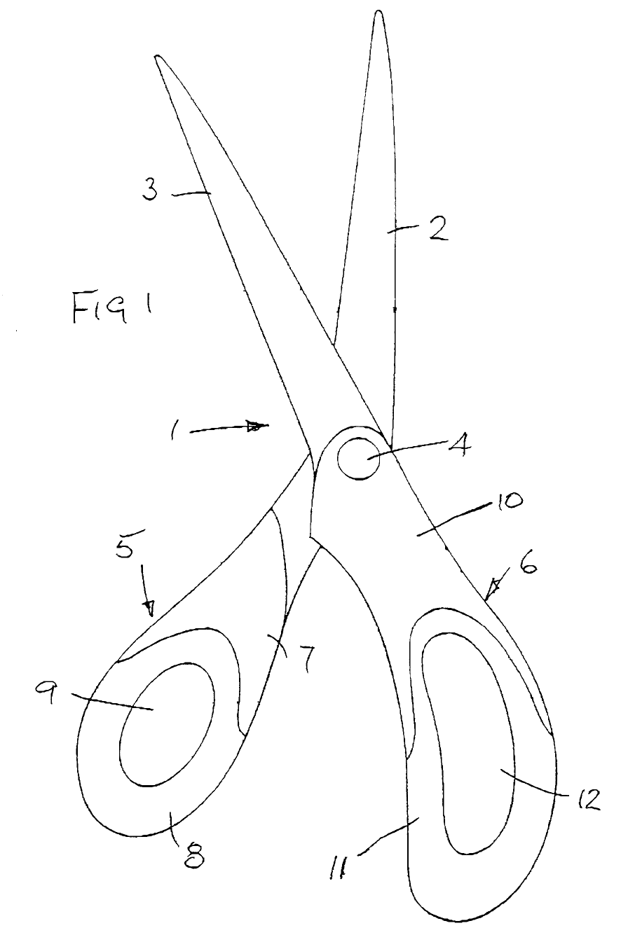

FIG. 1 is an elevation from one side of a large pair of scissors in the open condition;

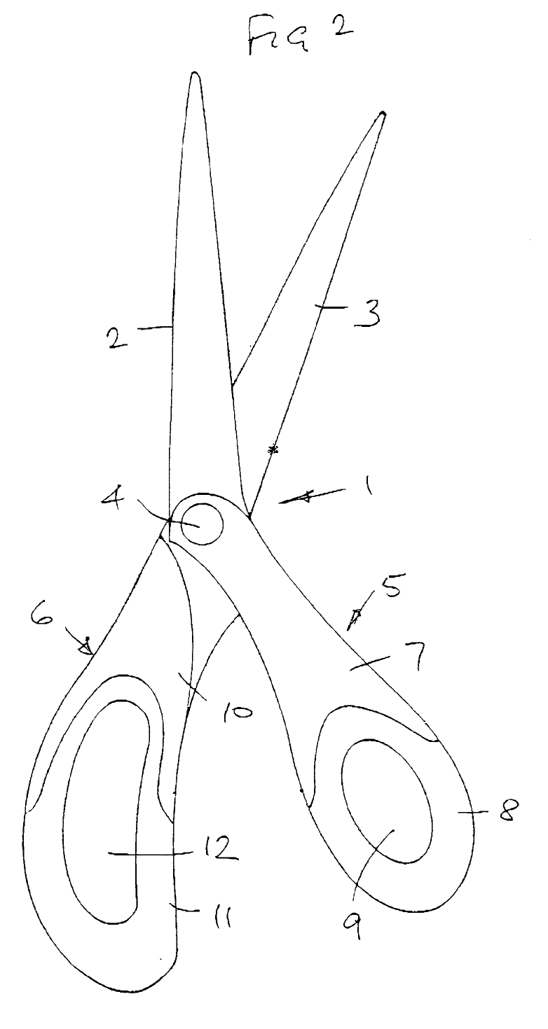

FIG. 2 corresponds to FIG. 1 but shows the opposite side;

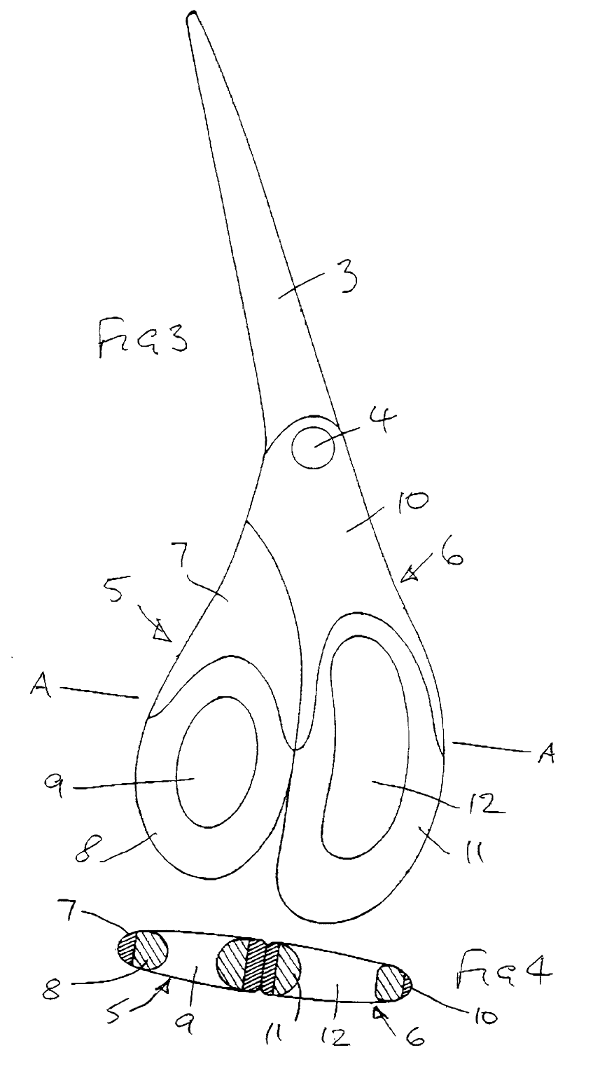

FIG. 3 corresponds to FIG. 1 but shows the scissors closed:

FIG. 4 is a section on the line A-A of FIG. 3;

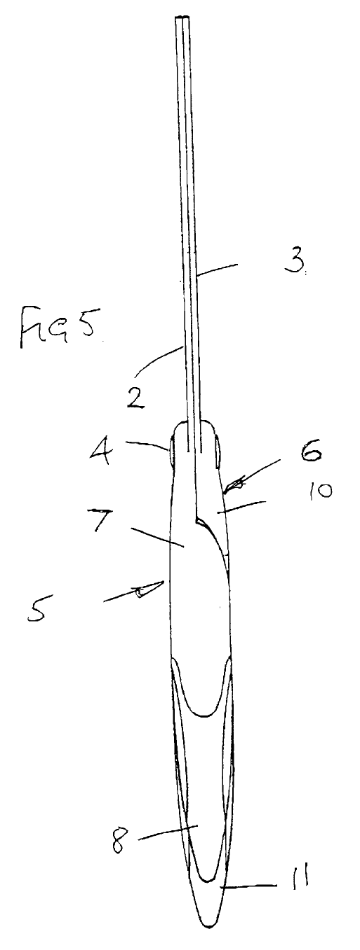

FIG. 5 is a side elevation of the scissors of FIG. 1;

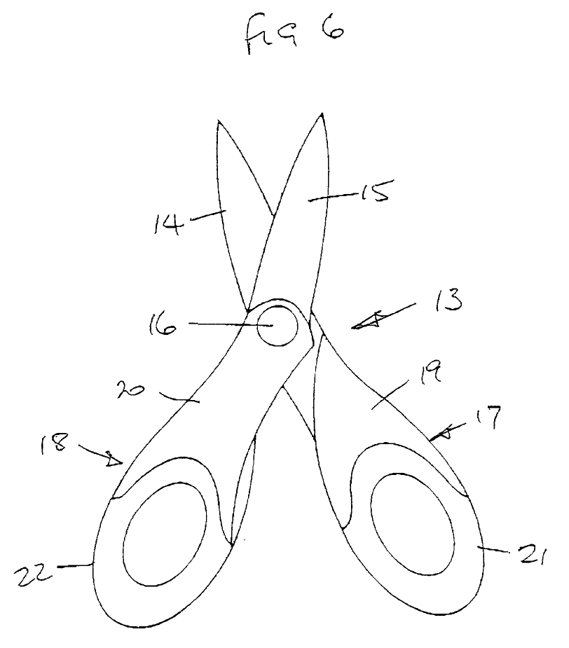

FIG. 6 is an elevation from one side of a small pair of scissors in the open condition;

FIG. 7 corresponds to FIG. 6 but shows the scissors closed and from the other side;

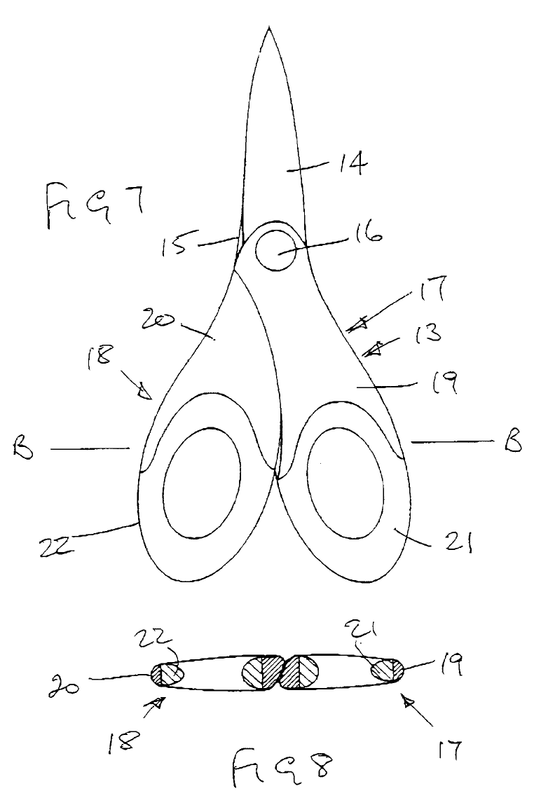

FIG. 8 is a section on the line B-B of FIG. 7; and

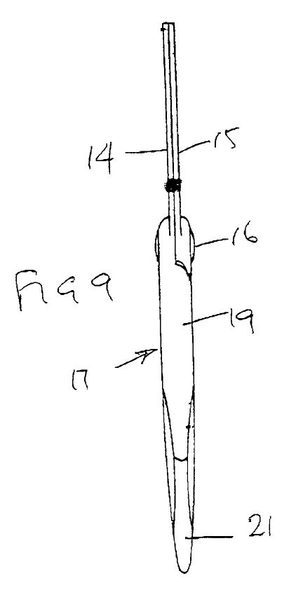

FIG. 9 is a side elevation of the scissors of FIG. 6.

In FIGS. 1 to 5, a large pair of scissors 1 has two blades 2, 3 pivoted together at 4, the blade 2 extending to a thumb bow 5 and the blade 3 extending to a figure bow 6. The thumb and finger bows 5, 6 are of relatively conventional shape, to allow the passage of the thumb through the thumb bow, and several fingers through the finger bow.

As is shown particularly by FIGS. 4 and 5, the scissors 1, and particularly the finger and thumb bows 5, 6 are symmetrical about the centre plane at the mid-point though their thickness.

The thumb bow 5 has a forward end 7 towards the pivot 4 formed from a rigid material, that may be a metal or an appropriate plastics material such as polypropylene, and from a point part way along the thumb bow 5, there extends a rearward part 8 formed from an appropriate form stable but resilient and/or flexible plastics material such as santoprene. As shown, the passageway 9 for the thumb through the thumb bow 5 is formed wholly within the rearward part 8 formed from the resilient and/or flexible material.

The finger bow 6 may be formed wholly from an appropriate rigid material that may be metal or plastics. However, the finger bow may also be formed with a forward part 10 towards the pivot of rigid metal or plastics material such as polypropylene, and a rearward part 11 of a form stable resilient and/or flexible plastics material such as santoprene, with the aperture 12 for the fingers formed wholly within the rearward part 11.

The forward and rearward parts of the thumb and finger bows may be separately formed and suitably secured together by adhesive or fusion, or they may be co-moulded together,

By having the handles formed symmetrical about their mid plane, the scissors are equally suited to use in either the left or the right hand. With the thumb and fingers of either hand located in the thumb 6 and finger bows 5 and with a cutting force applied to close the blades, pressure by the thumb to one side or the other of the rearward part 8 of the thumb bow, causes it to flex and bend about its connection to the forward part 7, and as a consequence render the scissors suitable for use in comfort by either right handed or left handed users.

In FIGS. 6 to 10, a small pair of scissors 13 is formed by blades 14, 15 pivoted together at 16, the blades extending to identical finger/thumb bows 17, 18 of relatively conventional shape, to allow the passage of the thumb and fingers through the bows.

As is shown particularly by FIGS. 9 and 10, the finger and thumb bows 15, 16 are symmetrical about the centre plane at the mid-point through their thickness.

Both bows are formed by respective forward parts 19, 20 towards the pivot, of a rigid metal or appropriate plastics material such as polypropylene, and from a point along their length with rearward parts 21, 22 of a form stable resilient and/or flexible material such as santoprene, and the apertures in both bows are formed wholly within the rearward parts 21, 22.

The forward and rearward parts of both bows may be separately formed and suitably secured together by adhesive or fusion, or may be co-moulded together.

By having both handles identically formed, and by having them formed symmetrical about their mid plane, the scissors are equally suited to use in either the left or right hand, and either way up.

With the thumb of either hand inserted through one or the other bow, and with a finger inserted through the other bow, and a cutting force applied to close the blades, pressure by the thumb to a respective side of the bow through which the thumb is inserted, causes it to flex and bend about its connection to the respective forward part of the handle, and as a consequence render the scissors suitable for use in comfort by either right or left handed users.

1. A pair of scissors comprising blades and associated handles pivotally secured together, the handles forming respective finger and thumb bows that are symmetrical about the centre plane at the mid-point through their thickness, at least one (thumb) bow being formed as a rigid structure from the forward end towards the pivot to a point along the length of that bow, from where the at least one (thumb) bow has a rearward part formed from a form-stable but resilient and/or flexible material.

2. A pair of scissors as in claim 1, wherein the aperture through the at least one (thumb) bow is formed wholly within the part of that bow formed from resilient and/or flexible material.

3. A pair of scissors as in claim 1 or claim 2, wherein the other (finger) bow of the pair of scissors is formed from hard material in conventional manner.

4. A pair of scissors as in claim 1 or claim 2, wherein the other (finger) bow of the pair of scissors is formed partly from hard material and partly from form-stable but resilient and/or flexible material.

5. A pair of scissors as in claim 4, wherein the aperture in the other (finger) bow is formed wholly within the part of that bow formed from resilient and/or flexible material.

6. A pair of scissors as in any of claims 1 to 5, wherein the two bows are identically formed.

7. A pair of scissors as in any of claims 1 to 5, wherein the finger bow is formed larger than the thumb bow.

8. A pair of scissors substantially as hereinbefore described with reference to FIGS. 1 to 5, and FIGS. 6 to 10 of the accompanying drawings.
